(19) United States
(12) Patent Application Publication
(10) Pub. No.: US 2011/0001935 A1
(43) Pub. Date: Jan. 6, 2011

(54) DIGITAL IMAGE PROJECTION SYSTEM

(75) Inventors: Brian Reale, Delray Beach, FL (US); Alex Tejada, New York, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Spotless, LLC, Cambridge, MA (US)

(21) Appl. No.: 12/666,099

(22) PCT Filed: Jun. 25, 2008
(86) PCT No.: PCT/US08/68137

§ 371 Date: May 17, 2010

Related U.S. Application Data
(63) Continuation-in-part of application No. 11/866,644, filed on Oct. 3, 2007.
(60) Provisional application No. 60/937,037, filed on Jun. 25, 2007.

(51) Int. Cl. G03B 21/14

(52) U.S. Cl. 353/28; 353/121

(57) ABSTRACT

Methods and systems for projecting an image on an object or objects in a performance area are described. Special visual effects may be created using these methods and systems. Information about the object(s) and performance area is acquired and used to process the visual effects. Using this information, images can be tailored to project various colors of light or specific images onto the objects or performers within a performance area by determining the objects' exact shape and adjusting the image accordingly. Continuous information acquisition can be employed to create images that change with the movements of performers and appear to interact in substantially real time with performers, audiences, or objects in the performance area. Multiple information acquisition devices can be used, as well as multiple projection devices, to create complex and interesting special effects.

### CROSS-REFERENCE TO RELATED APPLICATIONS

The subject matter disclosed herein claims priority to U.S. patent application Ser. No. 11/866,644, filed Oct. 3, 2007 and entitled “DIGITAL IMAGE PROJECTION SYSTEM,” which claims the benefit of U.S. Provisional Patent Application Ser. No. 60/937,037, filed Jun. 25, 2007 and entitled “DIGITAL FEEDBACK PROJECTOR”, which is hereby incorporated herein by reference in its entirety.

### BACKGROUND OF THE INVENTION

1. Field of the Invention

The present invention generally relates to projectors and lighting. More specifically, the present invention relates to a digital projector that projects images on a moving object and a lens unit adapter that may be used with a digital projector to provide image effects.

2. Description of the Related Art

One of the most important elements of a live performance is lighting. Proper and effective use of lighting can create dramatic effects and help ensure the success of a performance. There are many types of lights and lighting tools available which provide options to the stage manager or lighting technician. Different colored lights can be projected on a stage creating particular moods or impressions. Different sizes of spotlights or framed lighting effects are often used to light specific areas of a scene or performance. With the advent of laser technology, the granularity of lighting effects has been increased. Other special effects, such as strobe lighting, are available. However, lighting is typically somewhat limited in its flexibility, especially compared to the effects available through the use of computers in non-live entertainment. The most advanced lighting effects pale in comparison to the computer generated special effects that audiences are accustomed to seeing in film and television productions.

Projections of images, moving and stationary, can provide additional dramatic effect to live performances. The ability to project full images of scenes as background in a production can be an effective way to set a scene. Projected images may be used for other purposes, as well, providing additional tools to the lighting designer. However, these projections also suffer from limitations. Shadows from performers can cause the projection to become distorted and obvious to audiences. Projections must typically be projected onto a flat surface of a specific construction, such as a projection screen, in order to be properly viewed. And performers cannot believably interact with such projections. Thus, the current methods of using projected images or live productions have limited usefulness.

More advanced technologies have been developed which can detect the movements of performers or placement of objects and project specific images or lighting effects based on that information. However, these techniques still suffer many of the drawbacks of traditional lighting and image projection techniques. For instance, even though a spotlight may be able to follow a performer around the stage, it still has the limited functionality of a spotlight. The typical spotlight cannot be made to illuminate objects without having spillover light causing shadows. Images may be projected on a floor or background based on the movements of people or objects in the area, but the image projection technique suffers from shadowing, lack of interactivity with the performers, and projection surface requirements. Such mechanisms also lack the ability to customize the lighting effect to particular shapes of objects in the performance area, and modify that custom lighting effect to fit moving objects or performers. Therefore, it would be desirable to have a light and image projection system that would allow greater content capability than current lighting techniques, with the flexibility and interactivity that is currently impossible with image projection. It would also be desirable to have such a system that is easily adaptable to existing projection devices, and have components of the system integrated into projection devices.

### SUMMARY OF THE INVENTION

In one embodiment of the present subject matter, a digital feedback projection system is provided, which comprises image detection components, such as a lens unit adapter, which collect image data about a performance area and/or the objects or persons within the performance area and transmit that information to processing components. The processing components, which may include an intelligent effects unit, process the detected image and generate image an augmented image for projection. The processing components may also alter the image information to introduce image effects as desired. Such processing components may be programmable, increasing the flexibility of the digital feedback projection system. The processed image information is then sent to at least projector, which projects the image as provided by the processing components. The projector may be a readily available projector, and the light and image projection system may be configured so that such projectors are easily used with the system. In an alternate embodiment, multiple projectors may be used. In another alternate embodiment, one or more high resolution projectors may be used, and such projectors may be designed specifically for use with a digital feedback projection system.

Multiple image detection devices and components may be used, as well as multiple projection components, to create almost limitless special effects. Various inputs and detectors may be used to provide data for image processing. A background screen may be used with rear projectors, creating effects such as performers blending into a scene or becoming invisible. Very specific shape information can be obtained by the image detecting components, allowing one or more projectors to customize the image such that objects or performers have specific lighting or images projected only onto them, while the remainder of the projected image contains different lighting or images.

Various devices and components may be used to acquire information about a performance area and project images into the performance area. Thermal, infrared, 3-D LIDAR, 3-dimensional or regular color cameras may be used to acquire information. Arrays of cameras and inertial measuring units may be used to further supplement information derived from the performance area or from one or more objects. Variously powered projectors of various resolutions may be used in any combination and configuration such that the intended effects are created. Various numbers and types of intelligent effects units may be employed, and such units may be communicatively connected. Filtering mechanisms may be put in place so that devices projecting images do not interfere with devices acquiring image information, and vice versa. Each of the devices and components within a digital feedback projection system may be configured to communicate with each other over a network, which may be wired or wireless. Multiple digital feedback projection systems may also be connected and employed together to produce effects.

The present system and method are therefore advantageous in that they provide a means to project specific images exactly onto objects or performers in a performance area. Among other effects, this allows the projecting light into an object or performer without the creation of a shadow. In one embodiment, the present system and method perform a function similar to a spotlight, but without casting a shadow or having a “spot”. The present subject matter also allows such projections to dynamically update such that the images can be projected on moving objects in real-time. The present system and method also provide the advantage of detecting and incorporating the scenery and background of a performance area into a projected image, allowing the creation of a multitude of special effects, including performer invisibility and translucence. Using high speed GPUs, real-time effects such as the behavior of liquids and physical properties can be solved live, thus making the illusion that a performer is filled with liquid.

### BRIEF DESCRIPTION OF THE DRAWINGS

FIG. 1 is a graphical representation of an exemplary, non-limiting embodiment of a digital feedback projector.

FIG. 2 is a front view of a graphical representation of an exemplary, non-limiting embodiment of a light and image projection system.

FIG. 3 is a top view of a graphical representation of an exemplary, non-limiting embodiment of a light and image projection system.

FIG. 4 is a side view of a graphical representation of an exemplary, non-limiting embodiment of a light and image projection system.

FIG. 5 is a side view of a graphical representation of an exemplary, non-limiting embodiment of a lens unit adapter and related components.

FIG. 6 is a graphical representation of an exemplary, non-limiting embodiment of an intelligent effects unit and related components.

FIG. 7 is a front view of a graphical representation of an exemplary, non-limiting embodiment of a compact light and image projection system

FIG. 8 is a top view of a graphical representation of an exemplary, non-limiting embodiment of a integrated light and image projection system.

FIG. 9 is a graphical representation of an exemplary, non-limiting configuration of a digital feedback projector in a first mode of operation.

FIG. 10 is a graphical representation of an exemplary, non-limiting configuration of a digital feedback projector in a second mode of operation.

FIG. 11A is a graphical representation of the resulting effect created by one non-limiting, exemplary embodiment of the present disclosure.

FIG. 11B is a graphical representation of the resulting effect created by another non-limiting, exemplary embodiment of the present disclosure.

FIG. 12 is a graphical representation of an exemplary, non-limiting configuration of a digital feedback projector in a third mode of operation.

### DETAILED DESCRIPTION OF THE INVENTION

### Digital Feedback Projector Overview and Configuration

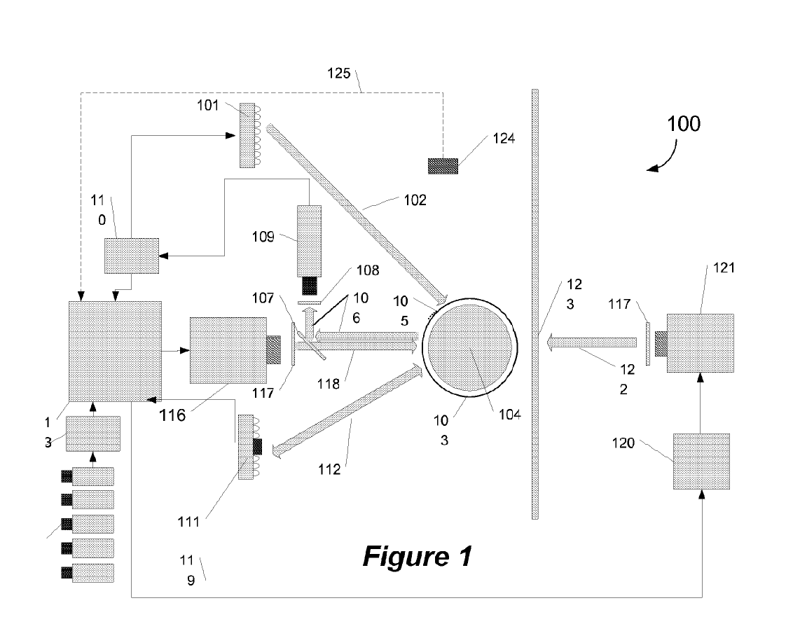

The systems and methods set forth herein may be embodied within a device or multiple devices referred to as digital feedback projector (DFP) systems. A DFP system may be composed of several components which provide the device with the ability to gather information from a performance area, including information about objects or performers within the performance area, and project images onto sections of the performance area or objects within the performance area. One non-limiting, exemplary embodiment of a DFP system is illustrated in FIG. 1. DFP system 100 includes several interdependent and interconnected components. In this embodiment, infrared light generator 101 projects infrared light 102 onto a surface 103 of object 104 within a performance area. Other light or wave generating components may be used, such as a light detection and ranging (LIDAR) device, a 3-dimensional (3-D) camera, an infrared thermal camera or a regular color camera. Any device or combination of devices which can generate waves, light or detectable particles that can be reflected off of objects or surfaces and then detected are contemplated as within the scope of the present subject matter. Moreover, more than one object may be involved in a performance area and the DFP system may operate in a performance area containing any number and variety of objects and backgrounds.

In one non-limiting, exemplary embodiment, surface 103 has a Lambertian reflective character, such that the apparent brightness of the surface to an observer is the same regardless of the observer's angle of view. Typically such surfaces are rough or matte, and not glossy or highly reflective. Object 104 may be any object within the performance area, for example, a person wearing clothing of a Lambertian character, such as a flat white leotard, or a building with matte, neutral colored stone or brick exterior. Other objects, including the background of a performance area or pedestrians on a city street are contemplated as within the scope of the present disclosure. All types of surfaces are also contemplated as within the scope of the present disclosure, including those of non-Lambertian character.

Reflected infrared light 106 is filtered through infrared 45-degree filter-mirror 107, which blocks visible light, and then through polarization filter 108 which rejects specular reflection. Filtered reflected infrared light 106 is then detected by infrared camera 109, which processes and communicates the image represented by infrared light 106 to image processor 110. Because different light, wave, or particle generating devices may be used other than infrared light generator 101, other types of cameras may be required to detect the reflected light, waves, or particles. For example, camera 109 may be a light detection and ranging (LIDAR) device, a 3-dimensional (3-D) camera, an infrared thermal camera, or a regular color camera. Likewise, other filtering and processing techniques and means may be required to allow such alternate embodiments to function as disclosed in the present disclosure. Thus, all such alternative embodiments are contemplated as within the scope of the present disclosure.

Image processor 110 extracts information on the individual objects, performers, or other items within the performance area and calculates the reflection coefficients on the entire surface of each such object. In one embodiment, invisible markings 105 may be placed on the surface of object 104. One example of an invisible marking material is infrared detectable ink. Other invisible markings may be in the form of special materials sewn into or attached to a performer's clothing, special materials used in paints, or make-up containing invisible marking material applied to the performers' bodies. Other means and mechanisms of creating invisible marking detectable only by particular detectors are contemplated as within the scope of the present disclosure, as well as implementation of the present subject without the use of invisible markings. Invisible markings 105 may be used to help the image processing software within image processor 110 to calculate the orientation of the object, the shape of the object, or other characteristics of an object. This information is sent to image synthesis graphics processing unit (GPU) 113 which may use such information for further calculations.

GPU 113 may be a single high speed GPU, or a combination of several GPUs and related components capable of performing the advanced and high speed calculations and processing required to accomplish the desired effects, including generating physics-based material effects in real-time. All such configurations of processing units and components are contemplated as within the scope of the present subject matter. GPU 113 is programmable and may be connected to all the necessary components required to run a computer program. Computer programs can be used to direct the GPU's processing such that the special effects images desired are created, providing great flexibility to the image designer.

In the illustrated embodiment, 3-dimensional (3-D) camera 111 may be used to obtain the true 3-D shape of object 104 from reflected rays 112. Many implementations of 3-D cameras are known to those skilled in the art, and any such camera which is capable of performing the tasks required of the present subject matter are contemplated as within the scope of the present disclosure. A 3-D camera capable of high frame-per-second rates is desirable for image processing where there are moving objects within the image, requiring continuous recalculation of the changing image. Information from 3-D camera 111 is sent to GPU 113. 3-D camera 111 may be used along with a thermal infrared camera, or other heat- or object-detecting cameras such as infrared camera 109, that picks up object heat or object shape information and sends such data to GPU 113. Such shape or heat information may include body heat generated by human or animal performers. GPU 113 can then perform the required processing and calculations to allow DFP system 100 to project certain images only onto a single object, specific objects, or parts of specific objects, or onto backgrounds or specific parts of backgrounds. This allows the system to tailor its projections to produce the desired effects.

In this embodiment, an array of five cameras 114 called environmental cameras (EMAC) is employed, which records in real time the images surrounding object 104. EMAC 114 cameras may be arranged in a cube format in order to register the entire contents of the performance area. The cube image processor 115 uses the five real time images derived from the five cameras in EMAC 114 camera array to give materials reflection or refraction information for the image that is to be projected by DFP system 100. Such information is then provided to GPU 113 for processing. Alternatively, the information from EMAC 114 may be fed directly to GPU 113, which may process EMAC information directly. Other numbers and configurations of cameras and processors may be used to create an EMAC camera array and process its data, and all such embodiments are contemplated as within the scope of the present subject matter.

Using the image information obtained from various sources, which may include EMAC 114, 3-D camera 111, infrared camera 109, and any other input sources or devices which measure the environment of and objects within the performance area, GPU 113 generates an image of the performance area including all of its physical parameters and shape information on objects contained therein, and renders a 3-D image. Any alterations of the image, or desired special effects, are also included in the image. Such alterations may include adding physics-based material effects. The 3-D image and related information is then sent to high resolution, high power digital projector 116. The light from projector 116 is then filtered by filter 117 that blocks all infrared light coming from the projector that can interfere with the other infrared sources. Filtered image 118 is then projected into the performance area. Other types of filtering as well as other projection mechanisms and means are contemplated as within the scope of the present disclosure.

The image projected by projector 116 may be an image covering the entire performance area, but containing altered image sections which are projected only on the exact shapes of objects or portions of the performance area to produce intended effects. For example, for an intelligent spotlight effect, the part of the image that is exactly covering the shape of a performer may be projected using bright light projection, while the remainder of the image covering those portions of the performance area not occupied by a performer are projected using dark light projection or shadow projection. Alternatively, a building may be within the performance area, and it may be projected using a wet, dripping paint image exactly within the contours of the building's shape, while the remainder of the performance area is projected in a contrasting colored light. As should be appreciated, many image effects are possible due to this aspect of the present subject matter. Even more complex and impressive effects may be achieved with the use of a DFP system having several projectors, which may be located at various locations in relation to the performance area. Projectors may be placed behind and to the sides of the performers to create an effect of a costume covering the entire body of the performer. Screens may be placed in locations within the performance area such that images can be projected from behind onto the screens, as well as from the front onto performers, such that performers can be made to appear translucent or invisible. Countless other effects are possible with the DFP system.

In the embodiment illustrated in FIG. 1, rear image 119 is generated by GPU 113 and sent to rear GPU 120 to be synchronized with front image 118. Rear GPU 120 processes rear image 119 as needed and sends the image to medium resolution, high power projector 121 which projects the image on rear screen 123. Other means and destinations for rear-projected images are contemplated, as well as not using rear projection at all. The rear projection is also filtered with infrared filter 117 which blocks infrared light in order to avoid projecting infrared light and interfering with other infrared detection cameras and systems. Other filters as well as multiple position projections systems utilizing other projection positions beyond, or instead of, front and rear projection are contemplated as within the scope of the present disclosure.

In one embodiment, inertial measurement unit (IMU) 124 is used to provide a virtual pointer system in the performance area to an object within the area, such as a human or animal performer. IMU signal 125 is transmitted to GPU 113 so that inertial and position information may be used by GPU 113 to create specialized effects. IMU signal 125 may be transmitted wirelessly, to facilitate ease of DFP system 100 set-up, or it may be transmitted using wires. Multiple IMUs may be installed to facilitate the creation of special effects. IMUs may serve as object positioning units, providing real-time data to the DFP system on the movements and changes in shape of objects or performers in the performance area to assist in providing special effects.

There are various possible configurations and combinations of components of a DFP. The particular configuration and component composition will be dependent on the desired effect and application. For example, several cameras, image acquisition devices, and projectors may be required for complex image projection in large areas. When several components are used spread around a large area, wireless transmission of data may be useful to ease installation of such a system. Multiple DFP systems may likewise be communicatively connected to produce a cohesive image effect. Alternatively, multiple DFP systems may be communicatively connected to produce distinct, but related effects. For instance, one or more DFP systems may be employed in a gaming system, such that individual gamers are illuminated with game-specific images, such as character costumes or wounds inflicted during the game. Various types of networks may be used to connect several DFP systems and/or their components, and any such network capable of carrying the required data is contemplated as within the present subject matter. Moreover, components of a DFP system, such as a projector or an image acquisition device, may be mounted on motorized mechanisms such that the component can follow a scene, objects, or performers, and perform the tasks necessary to produce the intended image or effects.

### Alternative DFP Configurations

In some embodiments, a DFP, which may also be referred to as a light and image projection system, may comprise any number of two major components, a lens unit adapter (“LUA”) and an intelligent effects unit (“IFXU”). The systems and methods set forth herein for a DFP or a light and image projection system may be embodied within a device or multiple devices containing or configured with one or more LUAs and IFXUs. A LUA and an IFXU may each be composed of several components which perform various functions related to creating image effects. A LUA and an IFXU may be configured to interoperate in order to create light and image effects. In one embodiment, one or more LUAs and IFXUs may be configured to operate with a digital projector which may be readily available in the marketplace, creating a light and image projection system. Such a configuration would allow an operator of the system to create special effects and other light and image effects using a readily available projector. A light and image projection system may also be composed of other interdependent and/or interconnected devices and components.

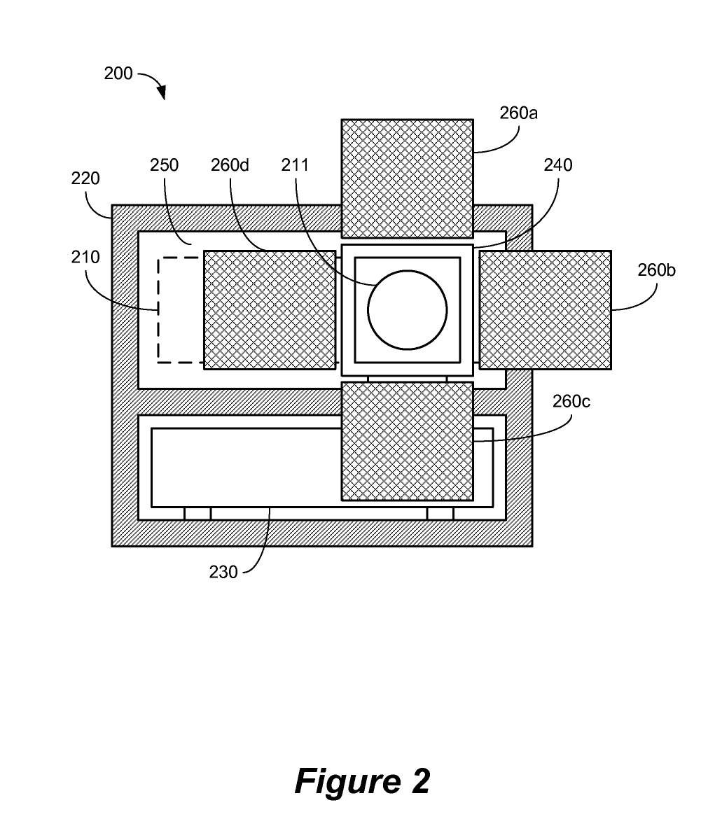

A frontal view of one non-limiting, exemplary light and image projection system 200 is illustrated in FIG. 2. Projector 210 may be installed within frame 220. Projector 210 may be any image projector, digital, analogue, or of any other type, which may project images and/or light into an area, including a spotlight or lighting element of any type. Projector 210 may be a readily available projector to which the light and image projection system may be adapted, or projector 210 may be a customized projector designed specifically for use with a light and image projection system. Projector 210 may be configured with one or more inputs which are configured to receive image data. Such inputs may be Universal Serial Bus (“USB”) inputs, coaxial inputs, Ethernet inputs, serial inputs, or any other input which may be used for transmitting and/or receiving image data. All such projectors and inputs are contemplated as within the scope of the present disclosure.

Frame 220 may be constructed of any suitable material, including metal, wood, plastic, composite material, or any other material or combination of materials that will serve the function of the present subject matter. Frame 220 may be readily available in the marketplace, or it may be a customized frame specially constructed to facilitate a light and image projection system. Frame 220 may also be a standard frame that may be found in many theater and performance venues. Frame 220 may have shelves, each of which may be used to contain or otherwise support components of a light and image projection system. Frame 220 may have other features or components that support or allow attachment of devices and/or components for light and image projection system 200. In FIG. 2, frame 220 has a top shelf, upon which is installed projector 210. Frame 220 also has a bottom shelf, upon which is installed IFXU 230, which will be described in more detail herein. Frame 220 may be stationary, or frame 220 may be mobile and/or configured to move through the use of motors or other means known to those skilled in the art. A non-stationary frame 220 may allow a system user to use light and image projection system 200 to light or project images onto one or more moving objects, allowing the operator to direct the image projected from projector 210 onto the moving object as it moves.

Optional adapter plate 250 may be affixed to frame 220 to hold or support various components of light and image projection system 200, and to perform other functions. Adapter plate 250 may be constructed of the same material as frame 220, or any other material the allows adapter plate 250 to serve the purposes of the present subject matter. Adapter plate 250 may have an opening through which lens 211 of projector 210 may project images and/or light. The opening in adapter plate 250 may be located anywhere in adapter plate 250 that allows a projector lens to project light and images. It is contemplated that various adapter plates may be constructed for use with various models and types of projectors and lights and various models and designs of frames. It is further contemplated that adapter plates may be adjustable and may be adjusted or manipulated to align with or fit to a particular projector. It is also contemplated that an adapter plate may not be necessary for all applications and configurations.

Attached to adapter plate 250 may be LUA 240, which is described in more detail herein. LUA 240 may be placed in front of lens 211, and may be configured to leave air circulation space between lens 211 and LUA 240 to facilitate cooling of these components. Alternatively, LUA 240 may be constructed with an active cooling mechanism of any type as known to those skilled in the art. In one embodiment, LUA 240 is not affixed to adapter plate 250, but instead affixed to frame 220 or some other attachment point. It is contemplated that LUAs may be constructed for use with various models and types of projectors and lights and various models and designs of frames. It is further contemplated that LUAs may be adjustable and may be adjusted or manipulated to align with or fit to a particular projector or projector lens. It is also contemplated that LUAs may include adjustments that allow the LUA to accommodate different lenses and projection settings.

Also attached to adapter plate 250 and/or frame 220 may be other devices or components of light and image projection system 200. In FIG. 2, infrared lamps 260a-260d may be attached to adapter plate 250. In another alternative, infrared lamps 260a-260d may be attached directly to LUA 240, to projector 210, to frame 220, or to any other appropriate attachment point Infrared lamps 260a-260d may project infrared light onto a performance area which is then reflected back and detected by LUA 240, and processed by IFXU 230, which is described in more detail herein. Infrared lamps 260a-260d may be adjustable and/or mobile, and may be positioned to provide the most effective use of such lamps. Infrared lamps 260a-260d may be mounted on motorized or otherwise movable devices or structures, and may be moved as needed via remote control or manually, as known to those skilled in the art. While four infrared lamps are shown in FIG. 2, any quantity of infrared lamps are contemplated, as well as no infrared lamps.

Other devices may be attached to frame 220, adapter plate 250, or other parts of light and image projection system 200 to enable the system to provide projected light and images as well as any desired special effects. For example, it is contemplated that other light or wave generating components or devices may be part of light and image projection system 200, such as a light detection and ranging (LIDAR) device, a 3-dimensional (3-D) camera, an infrared thermal camera or a standard color or black and white camera. Any device, component, or combination of devices and/or components that can generate waves, light or detectable particles that can be reflected off of objects or surfaces and then detected are contemplated as within the scope of the present subject matter as being configured in light and image projection system 200.

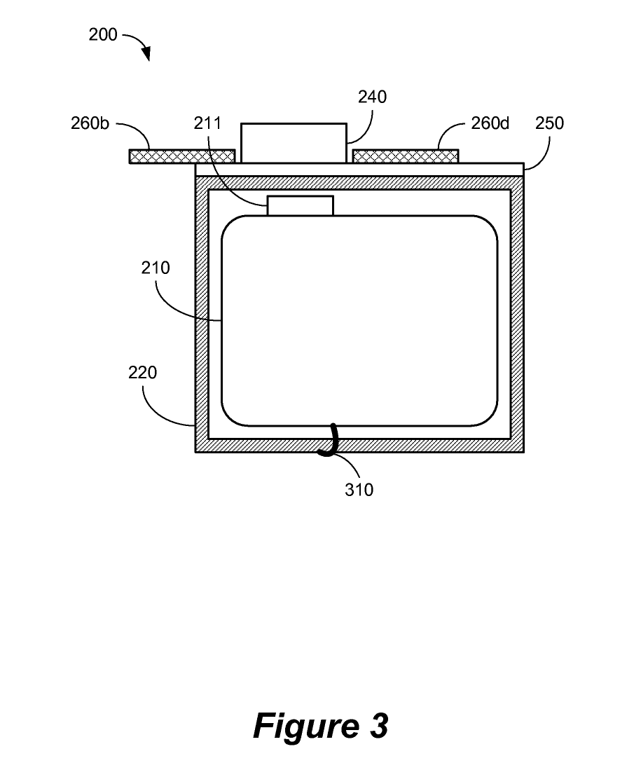

FIG. 3 illustrates a top view of light and image projection system 200. As seen in FIG. 3, projector 210 may be installed within frame 220, with lens 211 located behind adapter plate 250, and LUA 240. Infrared lamps 260b and 260d may be installed on either side of LUA 240. For clarity in the figure, elements above and below LUA 240 and projector 210, such as infrared lamps 260a and 260c and IFXU 230, are not visible in FIG. 3. Connector 310 may be connected to projector 210 and IFXU 230. Connector 310 may provide the means of transporting data, such as image data, between projector 210 and IFXU 230. Connector 310 may be any functional connector and constructed of any material that furthers the purposes of the present subject matter. For example, connector 310 may be copper or other metallic wire, fiber optic cable, coaxial cable, or any other means of transporting electrical or light signals. It is contemplated that more than one connection may be used. It is also contemplated that projector 210 and IFXU 230 may communicate wirelessly, using any wireless communication means known to those skilled in the art, such as WiFi, or BlueTooth. All such communications means and connections that enable two or more devices to communicate, including all wired and wireless means, are contemplated as within the scope of the present disclosure.

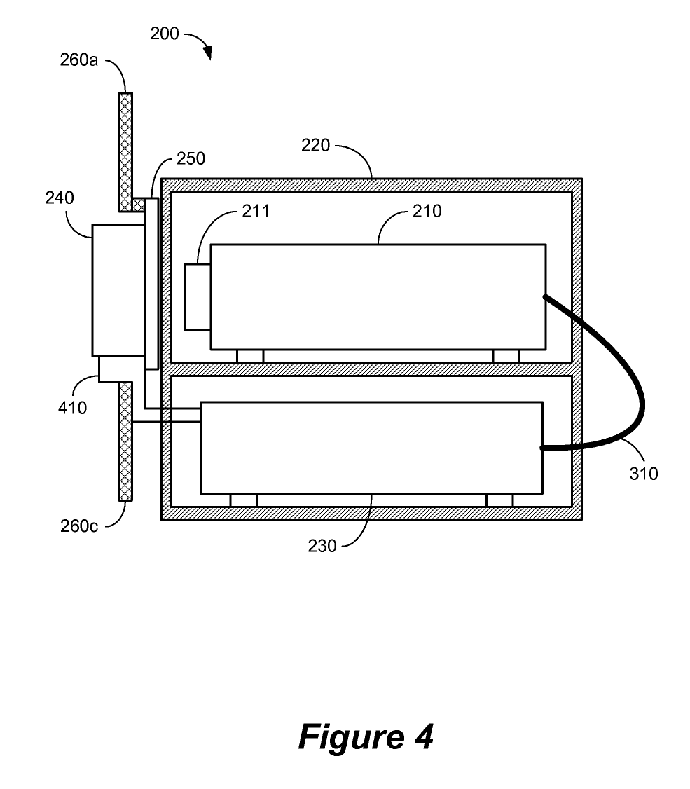

FIG. 4 illustrates a side view of light and image projection system 200. As can be seen in the figure, projector 210 may be installed on the top shelf of frame 220, with IFXU 230 installed on the bottom shelf. These two devices may be connected with connector 310. Adapter plate 250 may support infrared lamps 260a and 260c (as well as 260b and 260d which are omitted in FIG. 4 for clarity.) LUA 240 is located in front of lens 211 of projector 210. Detector 410 may be configured proximate to LUA 240, and may be an integral part of LUA 240 or a separate component. Detector 410 receives infrared light, other light, waves, particles, or other input from LUA 240 and processes such input, communicating the results to IFXU 230. Alternatively, detector 410 may simply detect and transmit the detected input to IFXU 230. Detector 410 may be connected to IFXU 230 through any effective means, including wires, cables, fiber optic connections, and any wireless means of communication. All such configurations and implementations of detector 410, IFXU 230, and LUA 240 are contemplated as within the scope of the present disclosure.

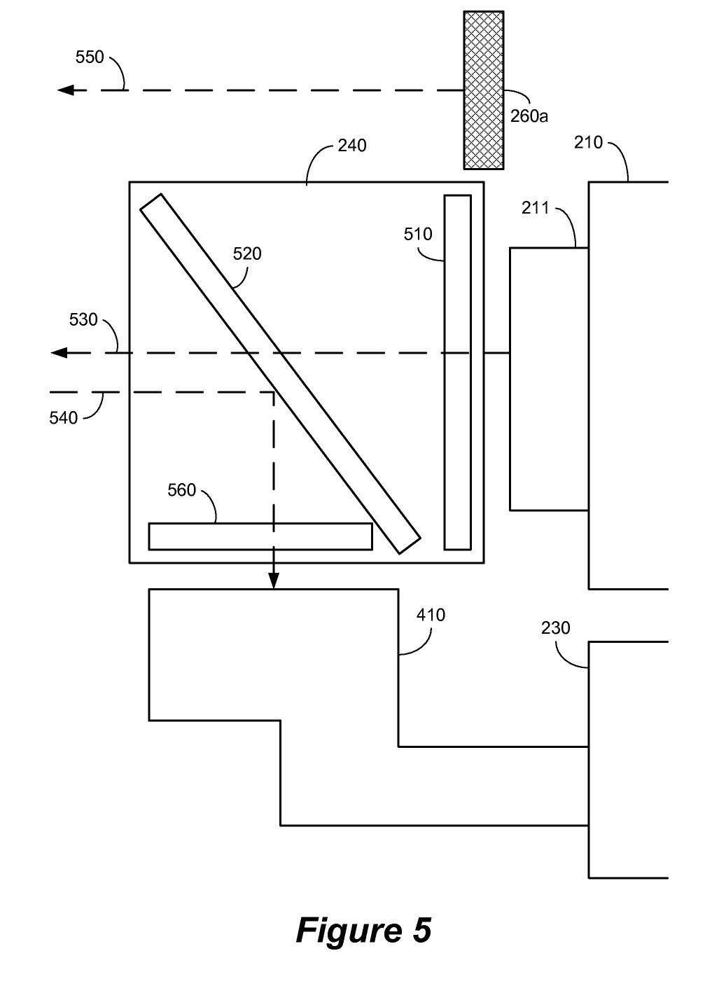

Referring now to FIG. 5, exemplary, non-limiting lens unit adapter (“LUA”) 240 is illustrated. Note that components and devices shown in other figures described herein may not be shown in FIG. 5 for clarity of the drawing; however, such components and devices may be present in the system described in regard to FIG. 5. LUA 240 may be affixed or configured to be in front of lens 211 of projector 210. Projector 210 may be projecting image 530 into an area or onto an object. LUA 240 may filter image 530 by placing filter 510 in the path of image 530. Filter 510 may block all infrared light coming from the projector. Infrared light from the projector may interfere with other infrared sources, detection of which may be important to the proper functioning of a light and image projection system as described herein. Filtered image 530 is then projected into an area or onto an object. Other types of filtering may be provided by filter 510, and multiple filters, as well as no filters, may be configured in LUA 240. Filters of any type and material, including glass, plastic, composite, material, or any other material, may be used in filter 510. Any and all filtering mechanisms and means are contemplated as within the scope of the present disclosure.

In one embodiment, infrared lamp 260a may be projecting infrared light 550 onto an area or object, which may also be illuminated by projector 210. Other light or wave generating components may be used, in addition to, or in place of, infrared lamp 260a, and multiple such light or wave generating components may be used. Examples of such components may include, but are not limited to, a LIDAR device, a 3-D camera, an infrared thermal camera or a regular color camera. Any device or combination of devices that can generate waves, light, or detectable particles that can be reflected off of objects or surfaces and then detected are contemplated as within the scope of the present subject matter.

Reflected infrared light 540 may filtered through infrared 45-degree filter-mirror 520, which may also block visible light. Filter-mirror 520 may be located at any angle which is conducive to directing reflected light into a detector. Filter-mirror 520 may be a one-way filter mirror, allowing image 530 to be projected through it without affecting or reflecting image 530. Reflected infrared light 540 may pass through polarization filter 560 which rejects specular reflection. Filtered reflected infrared light 540 may be detected by detector 410, which may process and communicate the image represented by infrared light 540 to IFXU 230. Because different light, wave, or particle generating devices may be used other than infrared lamp 260a, other types of detectors may be required to detect the reflected light, waves, or particles. For example, detector 410 may be a LIDAR device, a 3-D camera, an infrared thermal camera, or a regular color camera. Likewise, other filtering and processing techniques and means may be required to allow such alternate embodiments to function as disclosed in the present disclosure. Thus, all such alternative embodiments are contemplated as within the scope of the present disclosure.

It is contemplated that LUA 240 and elements associated therewith may be adjustable to accommodate or enhance LUA's 240 utility. For example, filter-mirror 520 may be adjustable in three axes to accommodate various types of detectors, such as detector 410, and to work with various detectors, projectors, frames, adapter plates, and/or other elements of a light and image projection system. Likewise, filter 510 may be adjustable in three axes to accommodate various types of projectors, such as projector 210, and to work with various detectors, projectors, frames, adapter plates, and/or other elements of a light and image projection system. Moreover, such elements may be adjustable to accommodate adjustments of related components. For example, filter 510 and filter-mirror 520 may be adjustable to accommodate a focus or zoom adjustment of lens 211. Any such adjustments of any component of device associated with a light and image projection system may be performed manually or automatically, and may involve the use of motors or other mechanical adjustment means. All such adjustments and flexible arrangements of components or devices are contemplated as within the scope of the present disclosure.

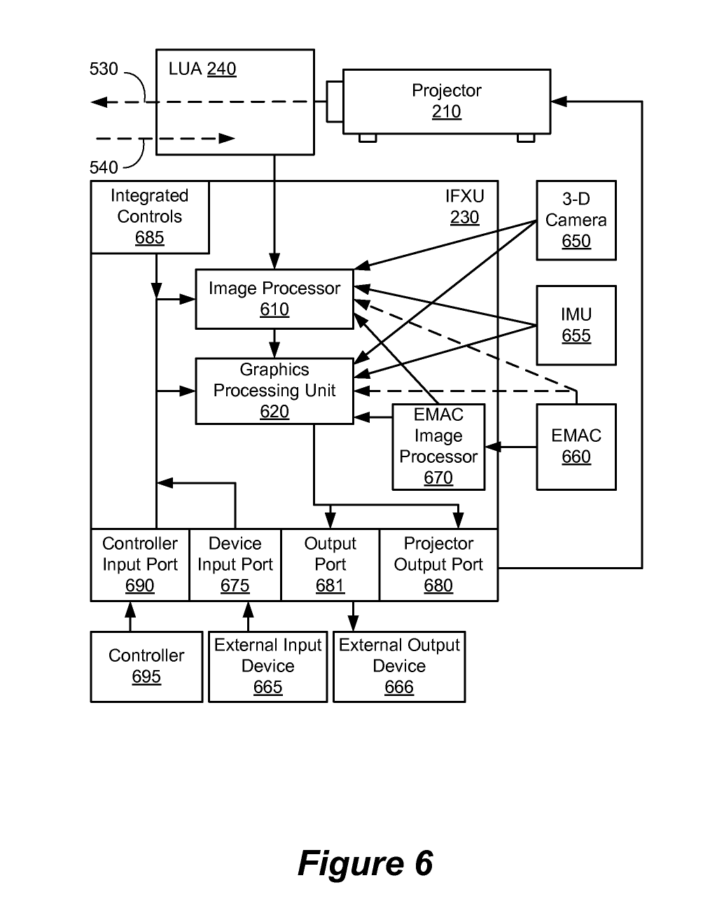

Intelligent effects unit (“IFXU”) 230 may contain or be configured with any number and variety of components that may be used to analyze, process, and create images to be projected into an area or onto an object. For example, and referring now to FIG. 6, IFXU 230 may include image processor 610 that extracts information on the individual objects, performers, or other items within the area or objects captured within reflected infrared light 540 transmitted from LUA 240. Image processor 610 may calculate the reflection coefficients on the entire surface of each such object or item. In one embodiment, invisible markings may be placed on the surface of objects detected by LUA 240. One example of an invisible marking material is infrared detectable ink which can be detected by LUA 240 by detecting reflected infrared light projected by infrared lamps 260a-260d. Other invisible markings may be in the form of special materials sewn into or attached to a performer's clothing, special materials used in paints, or make-up containing invisible marking material applied to the performers' bodies. Other means and mechanisms of creating invisible marking detectable only by particular detectors are contemplated as within the scope of the present disclosure, as well as implementation of the present subject without the use of invisible markings. Invisible markings may be used to help the image processing software within image processor 610 to calculate the orientation of the object, the shape of the object, or other characteristics of an object. This information may be sent to image synthesis graphics processing unit (“GPU”) 620 which may use such information for further calculations.

GPU 620 may be a single high speed GPU, or a combination of several GPUs and related components capable of performing the advanced and high speed calculations and processing required to accomplish the desired effects, including generating physics-based material effects in real-time. All such configurations of processing units and components are contemplated as within the scope of the present subject matter. GPU 620 may be programmable and may be connected to all the necessary components required to run a computer program. Computer programs can be used to direct GPU's 620 processing such that the special effects images desired are created, providing great flexibility to the image designer.

In some embodiments, input may be provided to IFXU 230 for processing from other sources. For example, 3-D camera 650 may be used in a light and image projection system. 3-D camera 650 may be used to obtain the true 3-D shape of objects within an area. Many implementations of 3-D cameras are known to those skilled in the art, and any such camera which is capable of performing the tasks required of the present subject matter are contemplated as within the scope of the present disclosure. A 3-D camera capable of high frame-per-second rates may be desirable for image processing where there are moving objects within the image, requiring continuous recalculation of the changing image. Information from 3-D camera 650 may be sent to image processor 610 and/or GPU 620. 3-D camera 650 may be used along with detector 410, or other heat- or object-detecting cameras and/or detectors that may be used to detect or determine object heat or object shape information and send such data to image processor 610 and/or GPU 620. Such shape or heat information may include body heat generated by human or animal performers. Image processor 610 and/or GPU 620 may then perform the required processing and calculations to allow a light and image projection system to project certain images only onto a single object, specific objects, or parts of specific objects, or onto backgrounds or specific parts of backgrounds. This allows the system to tailor its projections to produce the desired effects.

In another non-limiting embodiment, an array of two or more cameras called environmental cameras (“EMAC”) 660 may be employed that record in real time the images of objects, items, or an area. EMAC 660 may be arranged within an area in any effective way, such as in a cube configuration, in order to register the entire contents or selected contents of an area or objects within an area. The EMAC image processor 670 may use the real time images derived from EMAC 660 to give materials reflection or refraction information for the image that may be projector 210. Such information may then be provided to image processor 610 and/or GPU 620 for processing. EMAC image processor 670 may be located within EMAC 660, within IFXU 230, in one embodiment integrated into image processor 610 and/or GPU 620, or may be a separate device or component. Alternatively, the information from EMAC 660 may be fed directly to image processor 610 and/or GPU 620, which may process EMAC information directly. Other numbers and configurations of cameras and processors may be used to create an EMAC camera array and process its data, and all such embodiments are contemplated as within the scope of the present subject matter.

In yet another embodiment, inertial measurement unit (IMU) 655 is used to provide a virtual pointer system in an area to an object within the area, such as a human or animal performer. IMU 655 may transmit a signal to IFXU 230, which may be sent to GPU 620 or image processor 610 so that inertial and position information may be used by image processor 610 and/or GPU 620 to create specialized effects. The signal from IMU 655 may be transmitted wirelessly, to facilitate ease of set-up of a light and image projection system, or it may be transmitted using wires. Multiple IMUs may be installed to facilitate the creation of special effects. IMUs may serve as object positioning units, providing real-time data to a light and image projection system on the movements and changes in shape of objects or performers in the performance area to assist in providing special effects.

Other input may be provided to IFXU 230 by external devices connected to one or more device input ports such as device input port 675. External input device 665 may be connected to or communicate with IFXU 230 through device input port 675 using any means of communication known to those skilled in the art, including wired and wireless communication. External input device 665 may be a camera of any type, a digital or analog audio source, a digital or analog video source, any type of computing device, any type of light or wave emitting or detecting device, or any other device which may provide useful input to IFXU 230. External input device 665 may also be a computing device that contains images, effects, or other data which may be used to create images and/or effects. Such data may be provided to IFXU 230 through device input port 675 and used by image processor 610 and/or GPU 620 in processing the image to be provided to projector 210. IFXU 230 may have any number of device input ports such as device input port 675, to which may be attached any number of devices. Alternatively, such devices may communicate with IFXU 230 through other means not requiring an input port. All such configurations are contemplated as within the scope of the present disclosure.

Any type of information may be used by IFXU 230 in processing or generating image data and related information. Such information may or may not be detected and/or transmitted to image processor 610 and/or GPU 620 through LUA 240. For example, an input on IFXU 230, such as device input port 675, may receive music associated with a performance. In another embodiment, real-time data may be input into IFXU 230, such as results of a sporting competition or images of remotely located performers. Any other input, data, or other information that may be useful in the operation of a light and image projection system are contemplated as within the scope of the present disclosure.

Image processor 610 and/or GPU 620 generate image data and related information which describes, constructs, or otherwise enables an image to be projected, including all of the image's physical parameters and shape information on the projection area and/or objects contained therein. In the process of creating image data, image processor 610 and/or GPU 620 may use image information obtained from various sources, including EMAC 660, 3-D camera 650, LUA 240, IMU 655, external input device 665, and/or any other input sources or devices that measure the environment and/or objects or areas, and any additional input such as music and other image related data. Any alterations of the image, or desired special effects, are also included in the image data. Such alterations may include adding physics-based material effects. The image data and related information may be transmitted to one or more output ports such as projector output port 680. Projector output port 680 may be any port of any physical design and configuration and use any means known to those skilled in the art that can be used to transmit data and/or images, including USB, DMX, coaxial, Ethernet, wireless, IEEE 1394 (“Firewire”), VGA, DVI, or any other port and/or transmission means. Image data and related information may then be transmitted from projector output port 680 to projector 210, using any means and/or protocols that are known to those skilled in the art. Projector 210 may then project image 530 which may be rendered according to the image data and related information received from IFXU 230.

Image data and/or any data relating to images, image processing, IFXU 230, or any other data may be provided by IFXU 230 to other external devices for recording, processing, or any other use. Such data may be transmitted to one or more output ports such as output port 681. Output port 681 may be any port of any physical design and configuration and use any means known to those skilled in the art that can be used to transmit data and/or images, including USB, DMX, coaxial, Ethernet, wireless, IEEE 1394 (“Firewire”), VGA, DVI, or any other port and/or transmission means. Output port 681 may transmit data from IFXU 230 to external output device 666. External output device 666 may be a computing device such as a media server, a digital video server, or a web server. Alternatively, external output device 666 may be any device which may be connected to, communicate with, or be capable of receiving data from IFXU 230. Such devices may include analog or digital video or audio recorders, computer back-up systems, transmission systems such as television or radio transmission systems, or any other device.

External output device 666 may also be a device which assists in collecting or processing information and data. For example, external output device 666 may be an additional infrared lamp, controlled by IFXU 230 through output port 681. Alternatively, external output device 666 may be any other type of lamp, camera, light and/or wave detecting device, or any other device which assists in the function of a light and image projection system. IFXU 230 may have any number of output ports such as output port 681, to which may be attached any number and any type of devices. Alternatively, such devices may communicate with IFXU 230 through other means not requiring a physical output port. All such configurations are contemplated as within the scope of the present disclosure.

Image 530 projected by projector 210 may be an image covering an entire area, but containing altered image sections which are projected only on the exact shapes of objects or portions of the performance area to produce intended effects. For example, for an intelligent spotlight effect, the part of the image that is exactly covering the shape of a performer may be projected using bright light projection, while the remainder of the image covering those portions of the performance area not occupied by a performer are projected using dark light projection or shadow projection. Alternatively, a building may be within a performance area, and it may be projected using a wet, dripping paint image exactly within the contours of the building's shape, while the remainder of the performance area is projected in a contrasting colored light. As should be appreciated, many image effects are possible due to this aspect of the present subject matter. Even more complex and impressive effects may be achieved with the use of a light and image projection system having several projectors, which may be located at various locations in relation to an area. Projectors and/or other light and image projection systems may be placed behind and to the sides of the performers or a performance area to create an effect of a costume covering the entire body of the performer or a special effect filling in an area. Screens may be placed in locations within an area such that images can be projected from behind onto the screens, as well as from the front onto performers, such that performers can be made to appear translucent or invisible. Countless other effects are possible with a light and image projection system.

IFXU 230 may be configured and/or controlled by controller 695. Controller 695 may be a typical computer control device or several devices, such as a keyboard, mouse, and monitor. Alternatively, controller 695 maybe a separate computer, such as a laptop or desktop computer, that communicates with IFXU 230 using any device communications method well-known to those skilled in the art. In another alternative, controller 695 may be a DMX-512 console or other professional lighting control device. In yet another alternative, controller 695 may be a storage device that may be used to load data onto IFXU 230, such as a flash drive. Controller 695 may communicate with IFXU 230 using wired or wireless communications means, through controller input port 690. Controller input port 690 may be any type and number of input ports that allows one device to communicate with another device, including a USB port, Wi-Fi receiver/transmitter, or any other type of input port known to those skilled in the art. Controller 695 may use any protocol or communications standard known to those skilled in the art to communicate with controller input port 690, including DMX and Internet protocol (“IP”). Instructions and/or data for special effects and/or images may be created on IFXU 230 using controller 695, or they may be created on controller 695 and loaded onto IFXU 230. Such instructions and/or data may be processed or manipulated by image processor 610 and/or GPU 620, and may be stored in memory and/or other storage devices, such as disk drives, associated with or configured on IFXU 230.

IFXU 230 may have control functionality built-in which may allow control of IFXU 230 directly from the housing or exterior of IFXU 230. For example, integrated controls 685 may be configured on IFXU 230. Integrated controls 685 may allow an operator to control all or a subset of the functionality of IFXU 230 through manipulation of controls such as buttons, switches, touch pads, or any other input means known to those skilled in the art. Integrated controls 685 may also include a means for providing feedback to an operator, such as a display screen, one or more speakers, or any other means known to those skilled in the art. Integrated controls 685 may allow a user to configure IFXU 230 to create image effects or other manipulation of image data at IFXU 230 without having to use an external control device such as controller 695. IFXU 230 may be configured to be operable with both an external control device such as controller 695, and integrated controls 685. Any combination of controls and control devices are contemplate as within the scope of the present disclosure.

IFXU 230 may contain and/or be associated with other component and/or devices that may facilitate the purposes of the present disclosure. For example, IFXU 230 may have other ports for input and output, and may communicate with several projectors and/or lighting systems. IFXU 230 may have one or more storage components, including removable storage and/or non-removable storage, including, but not limited to, magnetic or optical disks, tape, flash, smart cards or a combination thereof. IFXU 230 may employ computer storage media, including volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by devices or components of IFXU 230, such as image processor 610 and GPU 620. All such storage media, devices, and components are contemplated as within the scope of the present disclosure.

In place of, or in addition to, controller input port 690 and device input port 675, IFXU 230 may also contain communications connection(s) that allow the IFXU 230 to communicate with other devices, for example through a wireless network or a local area network (“LAN”). Controller input port 690 and device input port 675 may accept any type of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land-line telephone, and wireless media such as acoustic, RF, infrared, cellular, and other wireless media. The term computer readable media as used herein includes both storage media and communication media. IFXU 230 may also have attached any type of input device(s), such as a keyboard, a keypad, a mouse, a pen, a voice input device, a touch input device, etc. IFXU 230 may also have any type of output device(s) attached, such as a display, speakers, a printer, etc.

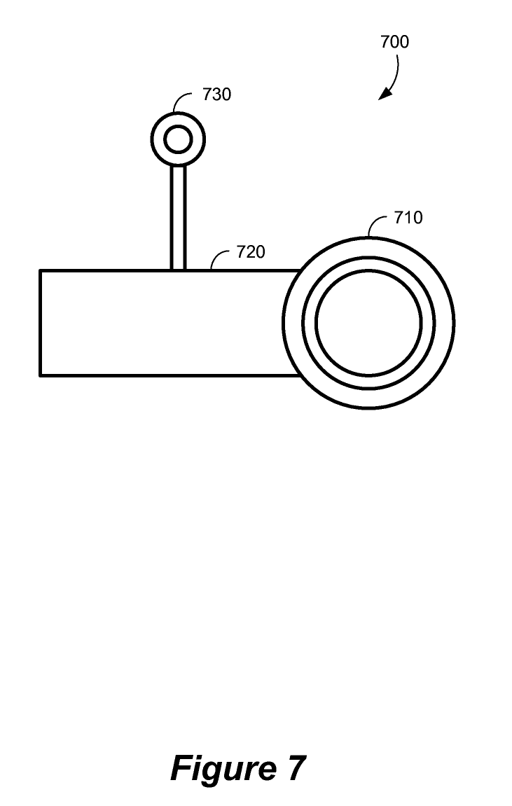

In yet another embodiment, a non-limiting exemplary embodiment of which is illustrated in FIG. 7, a compact light and image projection system may be constructed which facilitates portability and flexibility. Compact light and image projection system 700 is shown in FIG. 7. Attached to LUA 710 is a compact IFXU 720. Attached to IFXU 720 is compact lamp 730. Each of these elements may be contained in a single housing which may be easily attached or associated with a projector. A single unit such as compact light and image projection system 700 may be easily adapted to off-the-shelf projectors or lights, and may be useful in applications where space and/or expense need to minimized. Any of the components and devices described herein may be included within compact light and image projection system 700. Moreover, any of the methods and modes of operation described herein may be effectuated using a compact unit such as compact light and image projection system 700. All such embodiments are contemplated as within the scope of the present disclosure.

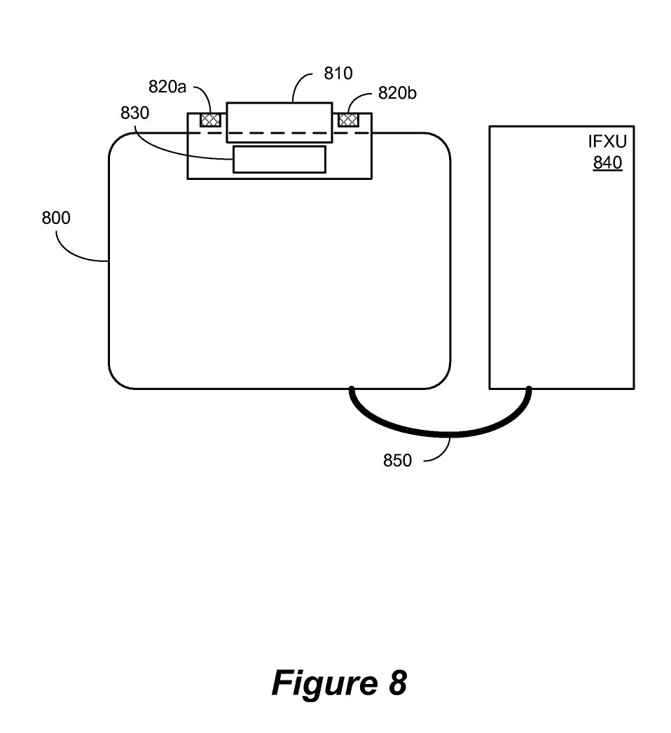

In still another embodiment, a non-limiting exemplary embodiment of which is illustrated in FIG. 8, projector may be constructed that incorporates an internal LUA into the projector housing, and allows the use of an external IFXU. Such a configuration may facilitate portability and flexibility. Integrated projector and LUA system 800 is shown in FIG. 8. Internal LUA 810 may be connected to and housed within integrated projector and LUA system 800. Internal LUA 810 may perform any of the tasks, illumination, and/or detection that may be performed by any LUA or similar component described herein. Integrated lamps 820a and 820b may be connected to and housed within integrated projector and LUA system 800. Integrated lamps 820a and 820b may be of any type of lamp as described herein or known to those skilled in the art. Lens 830 may also be housed within integrated projector and LUA system 800. Lens 830 may be a separate component of integrated projector and LUA system 800 from internal LUA 810, or internal LUA 810 may be integrated with lens 830 to create a single lens/LUA combination component. Likewise, lamps 820a and 820b may be integrated into a single component of integrated projector and LUA system 800 with internal LUA 810, lens 830, or both.

By integrating the LUA and related components into a projector to create a system such as integrated projector and LUA system 800, projectors may be offered which provide the illumination hardware required to operate a light and image projection system. The software and processing components may be housed in a separate component, such as external IFXU 840. External IFXU 840 may perform any of the tasks and/or processing that may be performed by any IFXU or similar component described herein. External IFXU 840 and integrated projector and LUA system 800 may communicate using any known means of communications, including wire 850. Any of the components and devices described herein may be included within integrated projector and LUA system 800 and external IFXU 840. Moreover, any of the methods and modes of operation described herein may be effectuated using integrated projector and LUA system 800. All such embodiments are contemplated as within the scope of the present disclosure.

### Methods and Modes of Operation

There are several modes and methods of implementing the present subject matter, some of which are described herein. Such methods and modes may be implemented using the DFP or light and image projection system described herein, or using other systems which facilitate the present subject matter. All other methods and modes of implementing the present subject matter are contemplated as within the scope of the disclosure. Special effects may be created by programming the DFP system, including its processing components such as IFXU 230 and IFXU 840, to process and project images according to computer programs.

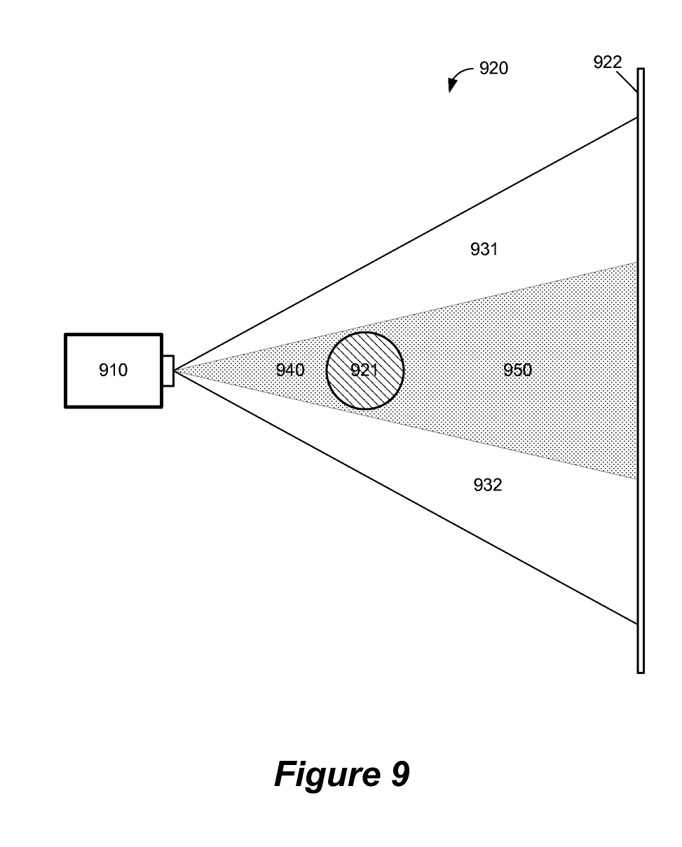

The first mode of operation may generally be used when there are one or more objects within the performance area, and the desired effect requires that the object or objects are not illuminated, while the objects' surroundings are illuminated. One effect which may be achieved using this mode of operation is the interaction by performers with a projected environment. For example, when ice skaters are skating across an ice rink, an effect may be produced which makes it appear as though they are leaving ripples in water on the ice rink as they skate. Such effects are only truly effective if the projected images are seen on the background but not on the performers. The present subject matter enables such effects. FIG. 9 illustrates one example of the present subject matter utilized in the first mode of operation. Performance area 920 contains object 921 and background 922. Object 921 may be a performer or multiple performers, or a stationary or mobile object of any type. Background 922 may be a screen installed in the performance area behind objects or performers, or it may be a floor in the performance area on which objects and/or performers sit or move. Other types of objects and backgrounds are contemplated as within the scope of the present disclosure.

DFP system projector 910 may project images into performance area 920. DFP system projector 910 may be a light and image projection system comprising projector 210, IFXU 230, LUA 240, and infrared lamps 260a-260b, or any other components or devices as described herein. Such devices or components may be installed or configured to project images into performance area 920. Using the various components discussed herein, and others which may facilitate the operation of the present subject matter, projector 910 acquires image information about the performance area and objects therein, and projects an image around object 921, so that the image does not fall on object 921, but only on the background. The image is projected in areas 931 and 932, which fall on background 922. Projector 910 projects dark light, or shadow, onto object 921 in area 940. Shadow area 950 is created behind object 921. Rather than merely directing light onto certain objects or in certain portions of the performance area, or physically following objects or movements of objects, projector 910 projects images onto the entire performance area. Projector 910 may project dark images, or shadow, where a bright image is not desired. By adjusting the areas of dark projection and bright projection to match the shape of objects, the DFP system can selectively project images onto various objects and backgrounds to create the desired effect. Desired effects may include physics-based material effects. In the case of a moving object, the DFP system constantly performs the calculations necessary to change the image as needed to maintain the desired effect. Such calculations may be performed in real-time, or near real-time by a GPU or other processor or combination of processors and components. Any such processing and means to accomplish said processing is contemplated as within the scope of the present subject matter.

By using a rear projecting DFP system, such as that illustrated in FIG. 1, shadow area 950 can be further illuminated behind object 921, thus creating a convincing effect of an object interacting with an environment projected by the DFP system. Alternatively, other projectors installed at various angles relative to the object may be used to project adjusted images, thus making it appear as though there is no shadow created by the object. The images projected by the DFP system can be dynamically altered using the component as described herein, making it appear as though the object is affecting the projected image. For instance, a performer can appear to be affecting the physical behavior of smoke, rain, or other airborne particles. Using images projected onto a floor or other horizontal background, a performer can appear to be interacting with projected images of creatures or water. As should be appreciated, the present subject matter offers almost limitless interactivity options.

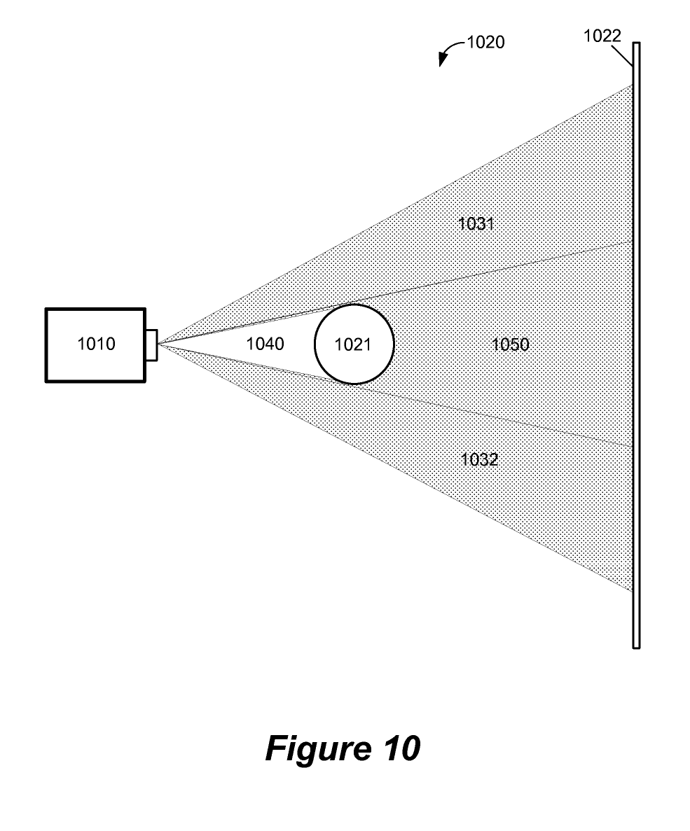

The second mode of operation is essentially the opposite of the first mode. In this mode, illustrated by FIG. 10, the bright projection is concentrated on object 1021, and dark projection is used surrounding object 1021 in areas 1031 and 1032, based on information acquired about performance area 1020 by the DFP system. Shadow area 1050 is created by object 1021. The effect of this mode of operation is to project specific image 1040 onto an object without affecting the surrounding performance area. Alternatively, a specific image may be projected on object 1021 while different images may be projected elsewhere in the performance area. This mode can be used to project images on performers using information about their exact shape which is continuously obtained and processed by the DFP system, making them appear to dynamically change costumes, face make-up, or appearance while in the performance area. Alternative uses include making objects appear to change color, texture, or material while being seen. As applied to people, this effect can be used to alter a person's appearance dynamically in conjunction with a performance or other activity. For example, gamers can be made to appear in certain costumes or wounds can be made to appear on them as they interact with the game and other gamers. Performers can be made to appear to change costume or make-up during a live performance. As applied to inanimate objects, examples of this effect include a building appearing to be covered in wet paint, or appearing to change from a brick exterior to a liquid metal exterior. An intelligent spotlight application is yet another possible use of the present subject matter. The DFP system can automatically adjust the bright light projection to conform to the exact shape of an object or performer, lighting the object or performer without causing any shadow effect because the bright light is shaped exactly to the shape of the object or performer with no spillover of bright light onto the background because the remainder of the performance area is projected with dark light.

In the embodiment illustrated in FIG. 10, as in that illustrated in FIG. 9, the background may be made to appear with a different image, shadows may be compensated for, or other effects may be employed by using multiple projection devices as part of the DFP system. For instance, an additional projection device may be employed in the rear, behind background 1022, projecting a different image and setting a background for object 1021. Additional projectors may be employed at different angles and positions such that the desired effect may be achieved. One results of such a multi-projector system is the appearance of invisibility of a performer. This is possible by programming the DFP system to project onto the performer images of the background of the performance area such that the performer matches and blends into the background. As should be appreciated, numerous other uses and effects are possible.

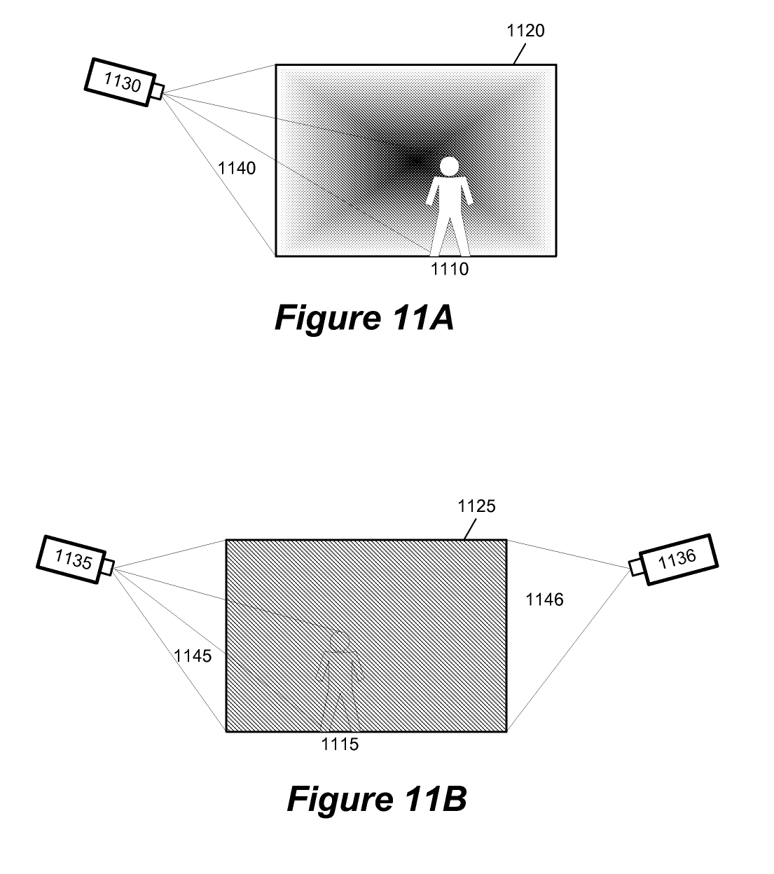

Examples of the result of implementing the present subject matter to achieve the effects described herein with regards to the first and second modes of DFP system operation are illustrated in FIG. 11. FIG. 11A illustrates an application of a DFP system in the first mode of operation described above. Image 1140 is projected by DFP system projector 1130 onto background 1120. Performer 1110 is standing in front of background 1120, however, because of the capability of the DFP system to detect and incorporate the shapes of objects and performers into projected images, the image 1140 is tailored such that performer 1110 does not have the background image projected onto him or her. Thus, background 1120 is illuminated with a specific image, while performer 1110 is not illuminated, or is illuminated with a different image. This illumination effect may be maintained while performer 1110 moves in front of background 1120, because, as described above, the DFP system can recalculate the shape of performer 1110 continuously and adjust projected image 1140 in real-time. A color camera, such as camera 109 in FIG. 1 which may be a color camera, may be used to adapt the projected color surface variations in order to adapt the image and compensate for true color projection.

FIG. 11B illustrates another potential visual effect made possible by implementing one embodiment of the DFP system. In this figure, the system is configured to create an illusion of performer invisibility, translucence, or blending into a background. DFP system projector 1135 projects image 1145 onto the front of background 1125, in front of which performer 1115 is positioned. DFP system projector 1136 projects image 1146 onto background 1125. Projector 1136 may be configured to project image 1146 onto the front of background 1125, or onto the rear of background 1125. For rear projection, a material such as that used in the construction of projection screens may be employed, so that the rear-projected image may be visible from in front of background 1125. The DFP system is programmed such that image 1145 projects exactly onto performer 1115 the content of the background image in front of which performer 1115 is standing, without projecting bright images outside of the shape of performer 1115, thus eliminating any shadows. Image 1146 is programmatically constructed to be the complete background image. Thus, an effect is created wherein performer 1115 matches the background, without casting a shadow, and thus creating an effect of blending into the background. The result of this effect may be near-invisibility or performer translucence. By using additional projectors and DFP system configurations, such effects can be even further enhanced.

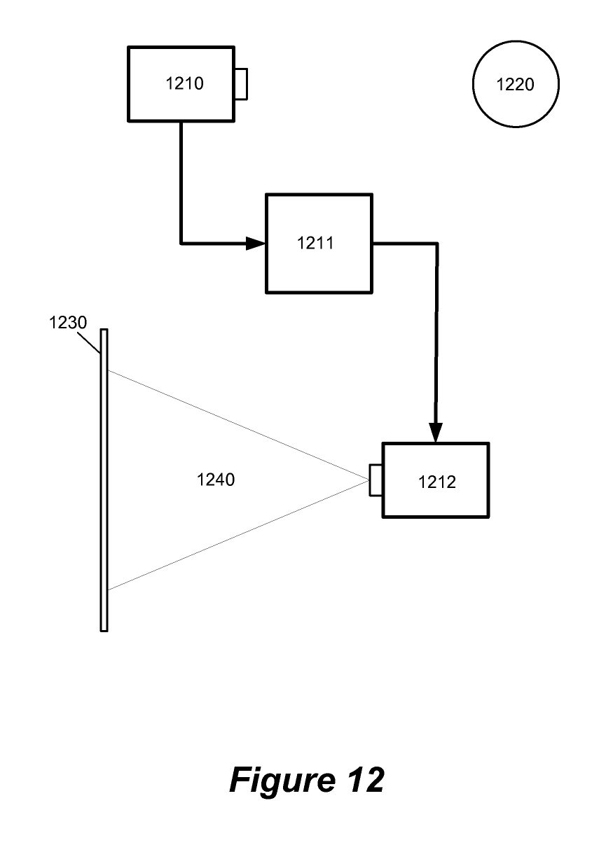

A third possible mode of operation is illustrated in FIG. 12. In this embodiment, the DFP system derives image information from one area and projects the image in another area. For example, image information may be derived from dancers in a room offstage, while the resulting image, complete with desired effects, is projected onto a screen onstage. In FIG. 12, one component of the DFP system, image acquisition device 1210, collects information about object 1220. Component 1210 may also collect information about the performance area in which object 1220 is located, and may collect information on several objects within the performance area. Component 1210 may be composed of any of the various detection and image acquisition technologies and means as recited herein, or any other means of mechanisms which provide some form of information or data on a live performance or performance area.

That information is relayed to processor 1211, which performs the necessary calculations and processing to prepare an image to be provided to projection device 1212. Such processing may include manipulation of the image to introduce special effects. For instance, dancers can be rendered as non-human creatures in a forest setting, or actors can be rendered as cartoon characters in an animated world. Processor 1211 may include one or more GPUs, and any other processors or components that accomplish the image processing tasks as described herein. Processor 1211 may be an IFXU as described herein, and may contain or be associated with any of the components described herein in relation to any configuration of any IFXU. Once processed, the image is transmitted to projector 1212, which projects the image onto a performance area. This may be a simple projection screen, or it may a less traditional projection area, such as a building or an arena floor. Other projection areas are contemplated as within the scope of the present subject matter, as are various other configurations and combinations of cameras, projectors, image acquisition devices, and processing systems.

As can be appreciated, combinations of the above modes of operation, as well as other modes of operation and combinations thereof, may be useful and effective in producing various desired imaging effects. Any components or configurations recited herein are intended to include equivalents and similar components and configurations that help achieve the objectives of the subject matter described herein. Also included within the present subject matter is any software, or storage medium containing such software, that enables any embodiment or portion of the present subject matter.

What is claimed is:

1. A digital feedback projector system, comprising:
an image detection system configured to capture at least 3-dimensional information about the physical location of at least one object within a performance area;
one or more processors configured to receive and process the captured performance area object information, generate substantially real-time, physics-based material effects that adapt to the shape of the at least one object, and generate image projection information incorporating the effects for the at least one object; and
an image projection system configured to receive the image projection information from the processor and project at least one image onto the at least one object within the performance area based on the image projection information.

2. The system of claim 1, wherein the at least one object is a person.

3. The system of claim 1, wherein the at least one object is inanimate and motive.

4. The system of claim 1, wherein the information captured within the performance area about the physical location of the at least one object includes information about the shape of the object.

5. The system of claim 1, wherein a first image is projected onto the at least one object and a second image is projected onto at least a portion of the performance area.

6. The system of claim 1, wherein the at least one object is marked with invisible markings detectable by only a specific type of detector.

7. The system of claim 1, wherein processing the captured performance area object information and generating image projection information includes altering the image to create a visual effect.

8. A method for projecting images substantially in real-time on at least one object in a performance area, comprising the steps of:
obtaining information on a performance area and at least one object therein, the object also being in a projection area;
processing the information to generate projection image information; and
projecting at least one image onto the at least one object within the projection area.

9. The method of claim 8, wherein processing the information to generate projection image information further comprises:
calculating the exact shape of the at least one object within the performance area from the information obtained on the performance area and the at least one object; and
generating projection information wherein a first image is projected onto the at least one object within the performance area using the at least one object's exact shape calculation, and a second image is projected onto at least one other portion of the performance area.

10. The method of claim 8, wherein information on the performance area is continuously obtained and processed, and wherein the image projected into the projection area is continuously updated.

11. The method of claim 8, wherein processing the information to generate projection image information further comprising altering the projection image information to introduce visual effects.

12. The method of claim 8, wherein projecting at least one image into a projection area further comprises projecting two or more images into the projection area from two or more projectors located in different parts of the area surrounding the projection area.

13. The method of claim 8, wherein projecting at least one image into a projection area further comprises:
projecting a first image onto the front of the projection area; and
projecting a second image onto a background from the rear of the projection area.

14. A system for projecting images onto at least one object within a performance area, comprising:
means for capturing information about the physical shape of at least one object in a performance area;
means for receiving and processing the captured performance area object information;
means for generating image projection information for the at least one object; and
means for receiving the image projection information from the processor and projecting at least one image onto the at least one object within the performance area based on the image projection information.

15. The system of claim 14, wherein the at least one object is a person.

16. The system of claim 14, wherein the at least one object is inanimate and motive.

17. The system of claim 14, wherein the information captured within the performance area about the physical location of the at least one object includes information about the shape of the at least one object.

18. The system of claim 14, further comprising means for projecting a first image onto the at least one object and projecting a second image onto at least a portion of the performance area.

19. The system of claim 14, wherein the at least one object is marked with invisible markings detectable by only a specific type of detector.

20. The system of claim 14, further comprising means for altering the at least one image based on the image projection information to create a visual effect.

21. A light and image projection system, comprising:
a lens unit adapter configured to detect information about an object in an area; and
an intelligent effects unit configured to receive and process the detected information and generate image projection data incorporating image effects based on the information, wherein the intelligent effects unit further comprises a transmitter for transmitting the image projection information to a projector.

22. The system of claim 21, further comprising a lamp, wherein the lamp projects detectable light into the area, and wherein the lens unit adapter detects reflected light.

23. The system of claim 21, wherein the lens unit adapter comprises a filter that filters a particular form of light from an image projected by the projector.

24. The system of claim 21, wherein the lens unit adapter comprises a filter-mirror that directs the detected information into a detector.

25. The system of claim 21, wherein the lens unit adapter, the intelligent effects unit, and the projector are affixed to a frame.

26. The system of claim 21, wherein the lens unit adapter is adjustable to accommodate the projector.

27. The system of claim 21, wherein the lens unit adapter is located in front of a lens of the projector.

28. The system of claim 21, wherein the detected information includes information about a shape of the object.

29. The system of claim 21, wherein a the intelligent effects units transmits a first set of image data to the first projector and a second set of image data to a second projector, and wherein the first projector projects a first image the object and the second projector projects a second image onto at least a portion of the area.

30. The system of claim 21, wherein the lens unit adapter is located within the housing of the projector.

31. A method for projecting images substantially in real-time on, at least, one object in an area, comprising the steps of:
detecting information on an area and an object therein, the object also being in a projection area;
processing the information to generate image projection information; and
transmitting the image projection information to a projector.

32. The method of claim 31, wherein processing the information to generate image projection information further comprises:
calculating the exact shape of the object within the area from the detected information; and
generating image projection information directing a projector to project a first image onto the object using the object's exact shape calculation and a second image onto at least one other portion of the performance area.

33. The method of claim 31, wherein information on the area is continuously detected and processed, and wherein the image projection information is continuously updated and transmitted to the projector.

34. The method of claim 31, wherein processing the information to generate image projection information further comprises including visual effects within the image projection information.

35. The method of claim 31, wherein image projection information further comprises two or more images, and wherein transmitting the image projection information to a projector comprises transmitting the two or more images to two or more projectors located in different parts of the area surrounding the projection area.

36. The method of claim 35, wherein transmitting the two or more images to two or more projectors further comprises:
transmitting a first image to a first projector, wherein the first projector projects the first image onto the front of the projection area; and
transmitting a second image to a second projector, wherein the second projector projects the second image onto a background from the rear of the projection area.

37. A system for projecting images onto at least one object within a performance area, comprising:
means for detecting information about the physical shape of an object in a performance area;
means for receiving and processing the detected information;
means for generating image projection information; and
means for transmitting the image projection information to at least one projector.

38. The system of claim 37, wherein the at least one object is a person.

39. The system of claim 37, wherein the at least one object is inanimate and motive.

40. The system of claim 37, wherein the detected information includes information about the shape of the object.

41. The system of claim 37, further comprising means for transmitting a first set of image projection information to a first projector, and means for transmitting a second set of image projection information to a second projector.

42. The system of claim 37, wherein the at least one object is marked with invisible markings detectable by only a specific type of detector.

43. The system of claim 37, further comprising means for altering the at least one image based on the image projection information to create a visual effect.

44. The system of claim 37, further comprising means from receiving input, the input being used by the means for generating the image projection information.

45. The system of claim 44, wherein the means for receiving input, the means for receiving and processing the detected information, and the means for generating the image projection information are contained in a single housing.
